(19) United States
(12) Patent Application Publication
(10) Pub. No.: US 2019/0152548 A1
(43) Pub. Date: May 23, 2019

(54) VEHICLE FRONT SECTION STRUCTURE AND VEHICLE FRONT SECTION COUPLING METHOD

(71) Applicant: TOYOTA JIDOSHA KABUSHIKI KAISHA, Toyota-shi (JP)

(72) Inventor: Kazuki SHIMIZU, Kariya-shi (JP)

(73) Assignee: TOYOTA JIDOSHA KABUSHIKI KAISHA, Toyota-shi (JP)

(21) Appl. No.: 16/158,769

(22) Filed: Oct. 12, 2018

(30) Foreign Application Priority Data
Nov. 21, 2017 (JP) 2017-223394

(51) Int. Cl. B62D 65/12; B62D 21/11; B62D 21/02; B62D 25/08; B62D 27/06; B62D 21/15

(52) U.S. Cl. CPC B62D 65/12; B62D 21/11; B62D 21/152; B62D 25/085; B62D 27/065; B62D 21/02

(57) ABSTRACT

A vehicle front section structure includes: a chassis module configured to be disposed at a vehicle front section, and including a drive unit, a suspension, and a suspension tower disposed upright at a vehicle width direction inner side of the suspension with the suspension being attached to the suspension tower; a rear-side coupling member configured to be disposed at a vehicle front side of a vehicle body-side member that is disposed further toward a vehicle rear than the chassis module, overlapping with the chassis module along a vehicle front-rear direction, and being coupled to the chassis module; and a fastener that fastens the chassis module and the rear-side coupling member together from a vehicle width direction outer side.

### CROSS-REFERENCE TO RELATED APPLICATION

This application claims priority under 35 USC 119 from Japanese Patent Application No. 2017-223394 filed Nov. 21, 2017, the disclosure of which is incorporated by reference herein in its entirety.

### BACKGROUND

### Technical Field

The present disclosure relates to a vehicle front section structure and a vehicle front section coupling method.

### Related Art

Japanese Patent Application Laid-Open (JP-A) No. 2012-144142 discloses an electric vehicle in which a drive unit is coupled to a front side frame by a mounting device, and including a suspension tower and a suspension cross member that supports a suspension. In an electric vehicle configured as in JP-A No. 2012-144142, when attaching the suspension to the suspension tower, this being a vehicle body-side member, the suspension tower needs to be disposed above the suspension to perform assembly. Manufacturing equipment to move the vehicle body in a vertical direction is thus necessary in a cumbersome assembly operation.

### SUMMARY

In consideration of the above circumstances, an object of the present disclosure is to obtain a vehicle front section structure and a vehicle front section coupling method enabling a suspension and a vehicle body-side member to be assembled by a simple operation.

A vehicle front section structure of a first aspect of the present disclosure includes a chassis module, a rear-side coupling member, and a fastener. The chassis module is configured to be disposed at a vehicle front section, and includes a drive unit, a suspension, and a suspension tower disposed upright at a vehicle width direction inner side of the suspension with the suspension being attached to the suspension tower. The rear-side coupling member is configured to be disposed at a vehicle front side of a vehicle body-side member that is disposed further toward a vehicle rear than the chassis module, overlaps with the chassis module along a vehicle front-rear direction, and is coupled to the chassis module. The fastener fastens the chassis module and the rear-side coupling member together from a vehicle width direction outer side.

In the vehicle front section structure of the first aspect, the suspension tower is included in the chassis module that is separate from the vehicle body. Accordingly, the suspension tower and the suspension can be assembled together away from the vehicle body in a chassis module manufacturing process.

Moreover, the chassis module and the vehicle body-side member can be assembled by a simple operation by overlapping the chassis module and the rear coupling member that is disposed at the vehicle front side of the vehicle body-side member along the vehicle front-rear direction, and by fastening the chassis module and the rear-side coupling member together with the fastener from the vehicle width direction outer side.

In a vehicle front section structure of a second aspect of the present disclosure, the rear-side coupling member is two extending front side members that extend from both vehicle width direction sides of the vehicle body-side member toward the vehicle front. The suspension is two suspensions, and the suspension tower is two suspension towers. Moreover, each of the two suspension towers and each of the two extending front side members are fastened together by the fastener at a first fastening portion in a state in which each of the two suspension towers and each of the two extending front side member overlap along the vehicle front-rear direction.

The vehicle front section structure of the second aspect enables the chassis module and the vehicle body-side member to be assembled together by fastening each of the suspension towers to each of the extending front side members that extends from both vehicle width direction sides of the vehicle body-side member toward the vehicle front.

In a vehicle front section structure of a third aspect of the present disclosure, the first fastening portion is disposed at a position that does not overlap with each of the two suspensions as seen from a vehicle side.

In the vehicle front section structure of the third aspect, each of the two suspension towers is fastened to each of the two extending front side members at a position that does not overlap with each of the two suspensions. This thereby enables a simple fastening operation, in which the suspensions do not cause an obstruction.

In a vehicle front section structure of a fourth aspect of the present disclosure, the chassis module includes two built-in front side members that extend along the vehicle front-rear direction at both vehicle width direction sides. Moreover, the rear-side coupling member is two projecting side members that project from lower portions on both vehicle width direction sides of the vehicle body-side member toward the vehicle front, each of the two built-in front side members and each of the two projecting side members are fastened together by the fastener at a second fastening portion in a state in which each of the two built-in front side members and each of the two projecting side member overlap along the vehicle front-rear direction.

In the vehicle front section structure of the fourth aspect, the chassis module is provided with the two built-in front side members, and the vehicle body-side member is provided with the two projecting side member. Each of the two built-in front side members and each of the two projecting side members overlap along the vehicle front-rear direction, and each of the two built-in front side members and each of the two projecting side members can be fastened together at the second fastening portion.

In a vehicle front section structure of a fifth aspect of the present disclosure, the second fastening portion is disposed further toward a vehicle rear than the suspension.

In the vehicle front section structure of the fifth aspect, each of the two built-in front side members and each of the two projecting side members can be fastened together at a position that does not overlap with the suspension, thereby enabling a simple fastening operation, in which the suspension does not cause an obstruction.

A vehicle front section coupling method of a sixth aspect of the present disclosure includes disposing a suspension tower at a vehicle width direction inner side of a suspension and attaching the suspension to the suspension tower to form a chassis module including a drive unit, the suspension, and the suspension tower. The chassis module and a rear coupling member, that is disposed at a vehicle front side of a vehicle body-side member that is disposed further to a vehicle rear than the chassis module, are moved in a vehicle front-rear direction relative to each other such that respective fastening portions of the chassis module and the rear coupling member overlap as seen from a vehicle side. The chassis module and the rear coupling member are fastened together from a vehicle width direction outer side at the fastening portions.

In the vehicle front section coupling method of the sixth aspect, the chassis module that includes the suspension tower is formed. The chassis module and the rear coupling member, that is disposed at the vehicle front side of the vehicle body-side member, are moved in the vehicle front-rear direction relative to each other, and the respective fastening portions of the chassis module and the rear coupling member are overlapped as seen from a vehicle side. The chassis module and the rear coupling member are fastened together from the vehicle width direction outer side at the fastening portions.

According to the vehicle front section coupling method of the sixth aspect, the chassis module and the rear coupling member are moved relative to each other in the vehicle front-rear direction such that their respective fastening portions overlap as seen from a vehicle side. Manufacturing equipment to move the vehicle body in a vehicle vertical direction is thus not needed. Moreover, since the chassis module and the rear coupling member are fastened from the vehicle width direction outer side at the fastening portions, assembly can be performed by a simple operation.

The vehicle front section structure and vehicle front section coupling method according to the present disclosure enable a suspension and a vehicle body-side member to be assembled by a simple operation.

### BRIEF DESCRIPTION OF THE DRAWINGS

Exemplary embodiments will be described in detail based on the following figures, wherein:

FIG. 1 is a perspective view illustrating a vehicle front section structure according to a first exemplary embodiment of the present disclosure, as viewed from above;

FIG. 2 is a side view illustrating a vehicle front section structure according to the first exemplary embodiment;

FIG. 3 is a perspective view illustrating a vehicle front section structure according to a second exemplary embodiment of the present disclosure, as viewed from above; and

FIG. 4 is a side view illustrating a vehicle front section structure according to the second exemplary embodiment.

### DETAILED DESCRIPTION

### First Exemplary Embodiment

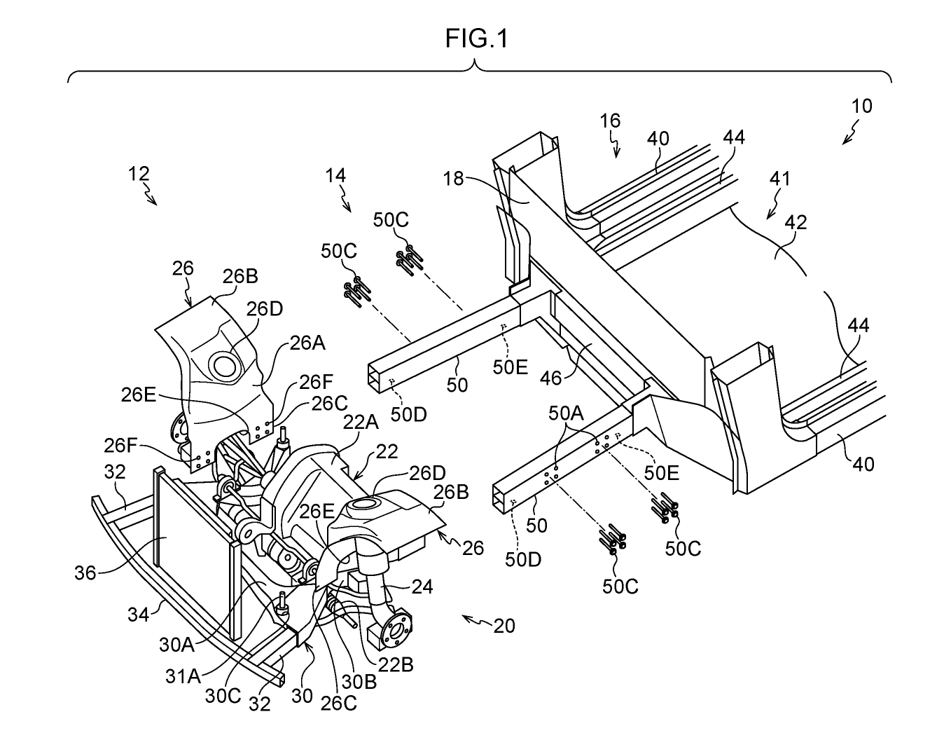

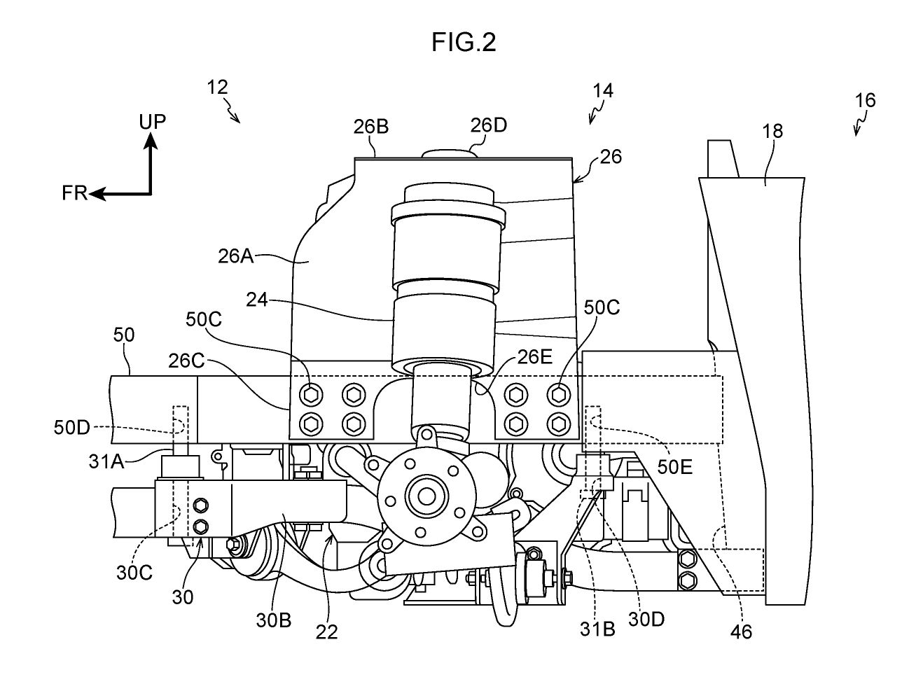

Explanation follows regarding a vehicle front section structure 12 according to a first exemplary embodiment of the present disclosure, with reference to FIG. 1 and FIG. 2. Note that in the drawings, arrow FR, arrow UP, and arrow W respectively indicate a front direction (direction of travel), an upper direction, and a width direction of the vehicle, as appropriate. In the following explanation, unless specifically indicated otherwise, reference simply to the front and rear, width, and upward and downward directions refers to the front and rear in a vehicle front-rear direction, the vehicle width direction, and upward and downward in a vehicle vertical direction.

As illustrated in FIG. 1, the vehicle front section structure 12 according to the present exemplary embodiment is applied to a front section of a vehicle 10, such as an electric vehicle, and includes a power unit chamber 14 and a vehicle cabin 16. The power unit chamber 14 and the vehicle cabin 16 are partitioned from one another by a dash panel 18. The power unit chamber 14 is disposed in front of the vehicle cabin 16.

A chassis module 20 is disposed in the power unit chamber 14. The chassis module 20 is configured including a drive unit 22, suspensions 24, suspension towers 26, a suspension member 30, lower side members 32, a lower reinforcement 34, and a radiator 36.

The drive unit 22 includes a motor 22A and a steering gearbox 22B. The motor 22A is disposed such that an output shaft thereof extends along the vehicle width direction W. The steering gearbox 22B extends along the vehicle width direction W below the motor 22A.

The drive unit 22 is supported by the suspension member 30 through a mounting member, not illustrated in the drawings. The suspension member 30 is configured including cross members 30A extending in the vehicle width direction W, and side rails 30B extending along the vehicle front-rear direction at vehicle width direction outer sides. The suspension member 30 is configured in a frame shape by coupling a pair of the side rails 30B together with two of the cross members 30A, the cross members 30A being disposed at a front-rear separation to each other. A front end portion and rear end portion of each side rail 30B are respectively formed with attachment holes 30C, 30D that are used to couple the side rails 30B to extending front side members 50, described later, using bolts.

The suspensions 24 are disposed at both vehicle width direction W outer sides of the motor 22A. Upper portions of the suspensions 24 are supported by the suspension towers 26, described later. The suspension towers 26 are plate shaped, and each includes a side wall 26A, a top wall 26B, and a lower joining portion 26C. The side wall 26A extends in the vertical direction such that a plate face of the side wall 26A faces substantially along the vehicle width direction. The top wall 26B is integrally formed so as to be continuous from an upper end of the side wall 26A and so as to curve toward the vehicle width direction W outer side. The top wall 26B is formed with a support portion 26D that supports a corresponding upper portion of the suspension 24. The suspensions 24 are disposed at vehicle width direction W outer sides of the respective side walls 26A, and the upper portions of the suspensions 24 are fixed to the respective support portions 26D using bolts (not illustrated in the drawings).

The lower joining portion 26C of each suspension tower 26 is configured integrally to a lower side of the side wall 26A so as to extend continuously downward therefrom, and is disposed so as to sandwich the suspension 24 from the front and rear. A recess 26E is formed at an inner side of the lower joining portion 26C that is split into front and rear. Attachment holes 26F for bolt fastening, described later, are formed through the lower joining portion 26C at both the front and rear sides of the recess 26E.

A front end portion of each of the pair of side rails 30B is coupled to the corresponding lower side member 32. Each lower side member 32 extends toward the vehicle front from a vehicle width direction outer side of a front end portion of the suspension member 30. The lower reinforcement 34 is attached to a front end of each lower side member 32. The lower reinforcement 34 extends in the vehicle width direction, and is coupled to the front ends of the pair of lower side members 32. The lower reinforcement 34 is disposed directly below a front bumper reinforcement, not illustrated in the drawings, so as to overlap with the front bumper reinforcement in the vehicle vertical direction. The radiator 36 is disposed between the lower reinforcement 34 and the suspension member 30 in the vehicle front-rear direction.

At least the aforementioned drive unit 22, the suspensions 24, the suspension towers 26, the suspension member 30, the lower side members 32, the lower reinforcement 34, and the radiator 36 are pre-assembled to configure the chassis module 20. Other necessary components and the like are also assembled to complete the chassis module 20, which is then coupled to the extending front side members 50, described later.

A pair of left and right rockers 40 that extend in the vehicle front-rear direction are provided at vehicle width direction outer sides of the vehicle cabin 16. The pair of left and right rockers 40 each configures a framework member formed with a closed cross-section. A battery housing section 41 is provided between the pair of rockers 40. The battery housing section 41 is disposed below the vehicle cabin 16, and includes a bottom plate 42, a battery frame 44, a battery (not illustrated in the drawings), and a battery front side portion 46. In the present exemplary embodiment, the rockers 40 and the battery housing section 41 configure vehicle body-side members of the present disclosure.

The bottom plate 42 is configured in an elongated substantially plate shape, and covers the entire battery housing section 41 from below. The battery frame 44 is configured in a frame shape with a uniform height, and is disposed running around an outer edge of the bottom plate 42. The battery is housed above the bottom plate 42, at the inside of the battery frame 44. The battery is capable of supplying electric power to the motor 22A and the like.

The battery front side portion 46 is provided at a front end of the battery frame 44. The dash panel 18 is provided above the battery front side portion 46. The extending front side members 50, serving as rear-side coupling members, are provided further toward inner sides from the rockers 40, on both vehicle width direction sides of the battery front side portion 46. Each of the extending front side members 50 is fixed to a front end of the battery frame 44 and extends toward the vehicle front. Each extending front side member 50 is configured with a square tube shaped closed cross-section structure, is formed with a cross-section resembling two rectangular shapes disposed one above the other, and configures a vehicle framework member. The extending front side members 50 are separated from each other at the vehicle width direction outer sides. A vehicle front-rear direction length of the extending front side members 50 is longer than a vehicle front-rear direction length of the suspension member 30 of the chassis module 20.

Note that the material and manufacturing method employed for the extending front side members 50 are not particularly limited. The extending front side members 50 may, for example, be formed from steel, aluminum, or resin materials by appropriate manufacturing methods.

Attachment holes 50A used for bolt-fastening to the suspension towers 26 are formed through vehicle width direction outer side walls of the extending front side members 50. Weld nuts (not illustrated in the drawings) are fixed at positions opposing the attachment holes 50A. An attachment hole 50D is formed through a lower side of a front end portion of each extending front side member 50. A weld nut (not illustrated in the drawings) is fixed at a position opposing each attachment hole 50D. An attachment hole 50E is also formed through a lower side of a rear end portion of each extending front side member 50. A weld nut (not illustrated in the drawings) is fixed at a position opposing each attachment hole 50E.

The front end portion of each extending front side member 50 is joined to the front bumper reinforcement (not illustrated in the drawings) extending in the vehicle width direction at a vehicle front end section by welding, fastening, or the like. Obviously, separate crash boxes, serving as shock absorbing members, may be interposed between the front end portions of the respective extending front side members 50 and the front bumper reinforcement.

The extending front side members 50 and the chassis module 20 are coupled together by the following procedure.

By disposing and moving the chassis module 20 from the front of the battery frame 44, the respective side rails 30B of the suspension member 30 are disposed below the extending front side members 50, such that the extending front side members 50 overlap the chassis module 20 in the vehicle front-rear direction. When this is performed, the attachment holes 30C, 30D at the suspension member 30 are overlapped with the attachment holes 50D, 50E at the extending front side members 50, and the attachment holes 26F at the suspension towers 26 are overlapped with the attachment holes 50A in the extending front side members 50. Then, bolts 31A are inserted into the attachment holes 30C, 50D from below, bolts 31B are inserted into the attachment holes 30D, 50E from below, and the extending front side members 50 and the suspension members 30 are fastened together. Bolts 50C are inserted into the attachment holes 26F, 50A from the vehicle width direction outer sides to fasten the extending front side members 50 to the suspension towers 26.

In the vehicle front section structure of the present exemplary embodiment, the chassis module 20 includes the suspension towers 26. Accordingly, in a manufacturing process of the chassis module 20, the suspension towers 26 and the suspensions 24 can be assembled together away from the vehicle body. Moreover, the chassis module 20 and the extending front side members 50 disposed at the vehicle front side of the battery frame 44 can be overlapped in the vehicle front-rear direction during assembly. In the present exemplary embodiment, the extending front side members 50 and the suspension towers 26 are overlapped with each other and fastened from the vehicle width direction outer sides using the bolts 50C, thereby enabling the chassis module 20 and a vehicle body-side member to be assembled together in a simple operation.

### Second Exemplary Embodiment

Next, explanation follows regarding a second exemplary embodiment of the present disclosure. In the present exemplary embodiment, portions similar to those of the first exemplary embodiment are allocated the same reference numerals, and detailed explanation thereof is omitted.

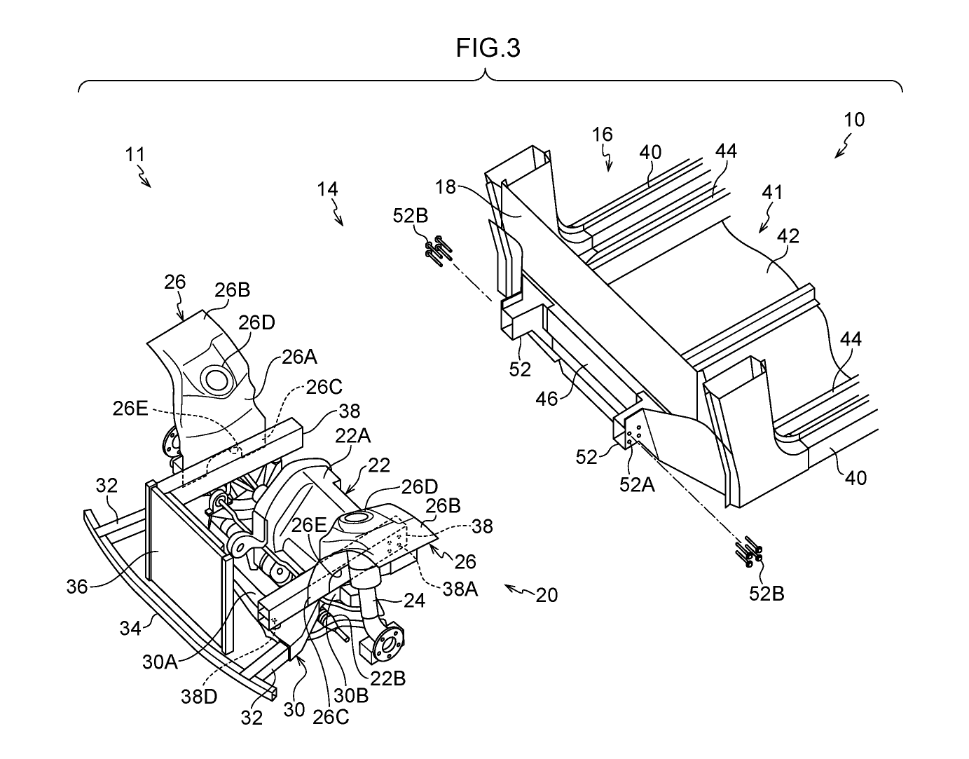

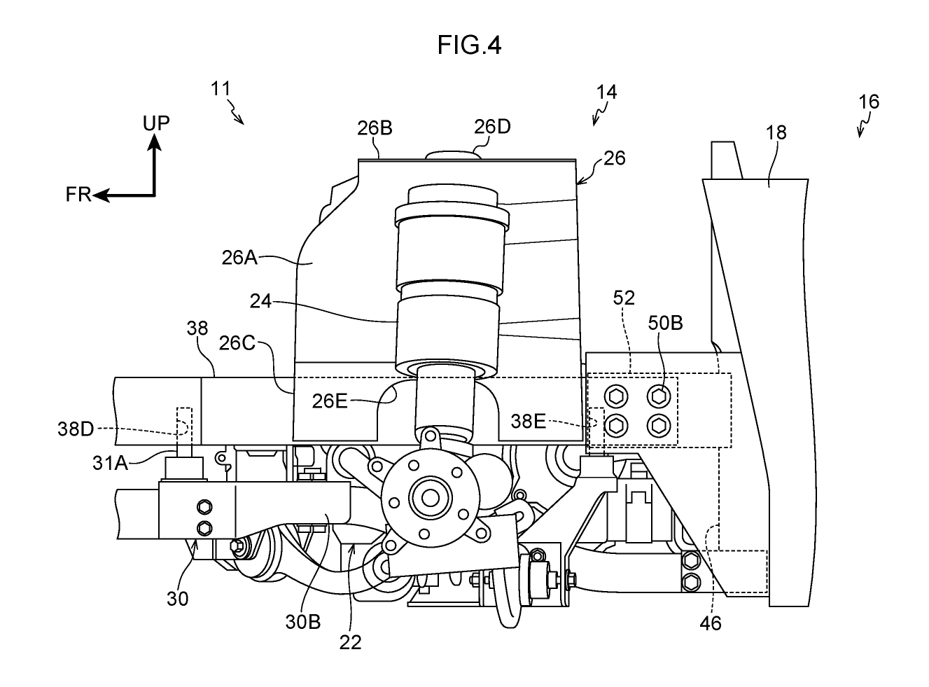

As illustrated in FIG. 3 and FIG. 4, a vehicle front section structure 11 of the present exemplary embodiment includes projecting side members 52 instead of the extending front side members 50 of the first exemplary embodiment. The chassis module 20 is provided with built-in front side members 38 in addition to the configuration of the chassis module 20 of the first exemplary embodiment.

The built-in front side members 38 are configured by members similar to the extending front side members 50, and configure vehicle framework members configured with a square tube shaped closed cross-section structure formed with a cross-section resembling two rectangular shapes disposed one above the other. The built-in front side members 38 are disposed at similar positions to the extending front side members 50 described above with respect to the chassis module 20. The built-in front side members 38 and the suspension member 30 are fastened together similarly to the extending front side members 50 and the suspension member 30 of the first exemplary embodiment. The built-in front side members 38 and the suspension towers 26 are not coupled together. The built-in front side members 38 are members belonging to the chassis module 20, and are preassembled in the chassis module 20.

The projecting side members 52 are fixed to a front end face of the battery front side portion 46, at similar positions to the extending front side members 50. The projecting side members 52 are each configured with a square tube shaped closed cross-section structure, and configure vehicle framework members. The projecting side members 52 are short in length, and are each configured with a profile that is larger than that of the corresponding built-in front side member 38 and that follows the outer profile of the built-in front side member 38. A vehicle width direction outer side wall 52C of each projecting side member 52 is formed with attachment holes 52A used when bolt fastening the corresponding built-in front side member 38. Weld nuts (not illustrated in the drawings) are fixed at positions opposing the attachment holes 52A. A vehicle width direction outer side of each built-in front side member 38 is formed with attachment holes 38A used when bolt fastening the corresponding projecting side member 52. An attachment hole 38D is formed through a lower side of a front end portion of each built-in front side member 38, and a weld nut (not illustrated in the drawings) is fixed at a position opposing the attachment hole 38D. An attachment hole 38E is formed through a lower side of a rear end portion of each built-in front side member 38, and a weld nut (not illustrated in the drawings) is fixed at a position opposing the attachment hole 38E.

In the chassis module 20, the built-in front side members 38 are assembled in a similar manner to that of the extending front side members 50 of the first exemplary embodiment. The attachment holes 30C, 30D in the suspension member 30 are overlapped with the respective attachment holes 38D, 38E at the built-in front side members 38, bolts 31A are inserted through the attachment holes 30C, 38D, bolts 31B are inserted through the attachment holes 30D, 38E, and the built-in front side members 38 are fastened to the chassis module 20. The projecting side members 52 and the chassis module 20 are coupled together by the following procedure.

By disposing and moving the chassis module 20 from the front of the battery frame 44, the built-in front side members 38 are inserted into the projecting side members 52 such that the built-in front side members 38 and the projecting side members 52 overlap in the vehicle front-rear direction. When this is performed, the attachment holes 38A in the built-in front side members 38 and the attachment holes 52A in the projecting side members 52 overlap each other, and bolts 52B are inserted into the attachment holes 52A, 38A from the vehicle width direction outer sides to fasten the built-in front side members 38 and the projecting side members 52 together.

In the vehicle front section structure of the present exemplary embodiment, the chassis module 20 includes the suspension towers 26. Accordingly, similarly to in the first exemplary embodiment, in a manufacturing process of the chassis module 20, the suspension towers 26 and the suspensions 24 can be assembled together away from the vehicle body. Moreover, the chassis module 20 and the projecting side members 52 disposed at the vehicle front side of the battery frame 44 can be overlapped with each other in the vehicle front-rear direction during assembly. In the present exemplary embodiment, the built-in front side members 38 and the projecting side members 52 are overlapped and fastened together from the vehicle width direction outer sides using the bolts 52B, thereby enabling the chassis module 20 and a vehicle body-side member to be assembled together by a simple operation.

Moreover, in the present exemplary embodiment, collision load can be transmitted smoothly due to coupling together the built-in front side members 38 and the projecting side members 52, both of which configure vehicle framework members.

Note that in the first and second exemplary embodiments, the chassis module 20 and the extending front side members 50, or the chassis module 20 and the projecting side members 52, are fastened together using bolts. However, mechanical fastening may be performed using other members, for example rivets.

Moreover, other members not described in the first or second exemplary embodiments, such as a non-contact charging battery, may be installed as members configuring the chassis module 20.

Note that in the first and the second exemplary embodiments, explanation has been given regarding examples in which the vehicle 10 is an electric vehicle. However, the vehicle front section structure of the present disclosure may be applied to other vehicles, such as gasoline-powered vehicles, fuel cell vehicles, hybrid vehicles, or the like.

What is claimed is:

1. A vehicle front section structure comprising:
a chassis module configured to be disposed at a vehicle front section, and including a drive unit, a suspension, and a suspension tower disposed upright at a vehicle width direction inner side of the suspension with the suspension being attached to the suspension tower;
a rear-side coupling member configured to be disposed at a vehicle front side of a vehicle body-side member that is disposed further toward a vehicle rear than the chassis module, overlapping with the chassis module along a vehicle front-rear direction, and being coupled to the chassis module; and
a fastener that fastens the chassis module and the rear-side coupling member together from a vehicle width direction outer side.

2. The vehicle front section structure of claim 1, wherein:
the rear-side coupling member is two extending front side members that extend from both vehicle width direction sides of the vehicle body-side member toward the vehicle front;
the suspension is two suspensions;
the suspension tower is two suspension towers; and
each of the two suspension towers and each of the two extending front side members are fastened together by the fastener at a first fastening portion in a state in which each of the two suspension towers and each of the two extending front side members overlap along the vehicle front-rear direction.

3. The vehicle front section structure of claim 2, wherein the first fastening portion is disposed at a position that does not overlap with each of the two suspensions as seen from a vehicle side.

4. The vehicle front section structure of claim 1, wherein:
the chassis module includes two built-in front side members that extend along the vehicle front-rear direction at both vehicle width direction sides of the chassis module;
the rear-side coupling member is two projecting side members that project from lower portions on both vehicle width direction sides of the vehicle body-side member toward the vehicle front; and
each of the two built-in front side members and each of the two projecting side member are fastened together by the fastener at a second fastening portion in a state in which each of the two built-in front side members and each of the two projecting side members overlap along the vehicle front-rear direction.

5. The vehicle front section structure of claim 4, wherein the second fastening portion is disposed further toward a vehicle rear than the suspension.

6. A vehicle front section coupling method comprising:
disposing a suspension tower at a vehicle width direction inner side of a suspension and attaching the suspension to the suspension tower to form a chassis module including a drive unit, the suspension, and the suspension tower;
moving the chassis module and a rear coupling member, that is disposed at a vehicle front side of a vehicle body-side member that is disposed further to a vehicle rear than the chassis module, relative to each other in a vehicle front-rear direction such that respective fastening portions of the chassis module and the rear coupling member overlap as seen from a vehicle side; and
fastening the chassis module and the rear coupling member together from a vehicle width direction outer side at the fastening portions.
